(19) United States
(12) Patent Application Publication
(10) Pub. No.: US 2015/0227311 A1
(43) Pub. Date: Aug. 13, 2015

(54) SELECTING ALTERNATE KEYS USING MULTI-TOUCH

(71) Applicant: Lenovo (Singapore) Pte. Ltd., Singapore (SG)

(72) Inventor: Joseph Robert Parker, Hillsborough, NC (US)

(73) Assignee: Lenovo (Singapore) Pte. Ltd., Singapore (SG)

(21) Appl. No.: 14/178,405

(22) Filed: Feb. 12, 2014

(51) Int. Cl. G06F 3/0488; G06F 3/023

(52) U.S. Cl. CPC G06F 3/04886; G06F 3/04883; G06F 3/0236

(57) ABSTRACT

An aspect provides a method, including: detecting, at a touch sensitive surface of an information handling device, a multi-touch input to a soft keyboard; and rendering an alternative input mapped to the multi-touch input; the multi-touch input being a substantially simultaneous multi-touch input to one or more character soft keys. Other aspects are described and claimed.

### BACKGROUND

Information handling devices (“devices”) come in a variety of forms, for example desktop or laptop computing devices, tablet computing devices, smart phones, navigation devices, and the like. Many such devices operate using a soft keyboard, e.g., a keyboard displayed on a touch screen display device. The soft keys of the keyboard may be pressed to enter character inputs such as letters, numbers and symbols.

Commonly devices attempt to consolidate soft keyboards in terms of size such that many keys may be provided only via selection of a control key, such as a shift key or an alternate/alternative key set display key. In this way, a user may provide a first touch input and thereafter provide additional touch input(s) to select alternate soft keys.

### BRIEF SUMMARY

In summary, one aspect provides a method, comprising: detecting, at a touch sensitive surface of an information handling device, a multi-touch input to a soft keyboard; and rendering an alternative input mapped to the multi-touch input; said multi-touch input being a substantially simultaneous multi-touch input to one or more character soft keys.

Another aspect provides an information handling device, comprising: a touch sensitive surface; a display; a processor operatively coupled to the touch sensitive surface and the display; a memory device that stores instructions accessible to the processor, the instructions being executable by the processor to: detect, at the touch sensitive surface, a multi-touch input to a soft keyboard; and render on the display an alternative input mapped to the multi-touch input; said multi-touch input being a substantially simultaneous multi-touch input to one or more character soft keys.

A further aspect provides a product, comprising: a storage device having code stored therewith, the code being executable by a processor and comprising: code that detects, at a touch sensitive surface of an information handling device, a multi-touch input to a soft keyboard; and code that renders an alternative input mapped to the multi-touch input; said multi-touch input being a substantially simultaneous multi-touch input to one or more character soft keys.

A still further aspect provides a method, comprising: detecting, at a touch sensitive surface of an information handling device, a multi-touch input to a soft keyboard; and rendering an alternative input mapped to the multi-touch input; said multi-touch input being a sequential multi-touch input comprising a first touch input provided to a control soft key and a second touch input to a character soft key during a continuation of said first touch input; wherein said rendering an alternative input mapped to the multi-touch input comprises rending alternative inputs for a duration of time during which the first touch input is detected at the control soft key.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example selecting alternate keys using multi-touch.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Touch-enabled devices such as tablet computing devices, smart phones, etc., implement a software based touch keyboard (“soft keyboard”) that typically takes a single input to select a single key. As described herein, to accommodate the small amount of screen space reserved for the keyboard for example in touch screen implementations, soft keyboards need to allow for each key to represent one or more alternate keys. However, accessing the alternate keys can make the user's input slower and less natural.

For example, it is common on touch-enabled devices to implement a soft keyboard where each soft key may be long-pressed (press and hold for some predetermined time) to select an alternate soft key for that input space. The waiting for the long-press to take affect slows down the user's input and impairs their normal typing rhythm.

Accordingly, an embodiment provides for more intuitive selection of alternate soft keys and thus providing alternate soft key inputs. An embodiment utilizes selecting alternate keys using multi-touch input. For example, an embodiment may detect multiple touch points to the soft keyboard, e.g., substantially simultaneously (such as detected at the same time or within a predetermined time less than an average time used to provide sequential inputs). Responsive to detecting a simultaneous multi-touch input, an embodiment may input an alternate key input, e.g., a key input not associated with either portion of the multi-touch input alone.

These substantially simultaneous touch inputs may be mapped to alternate soft key inputs in a variety of ways. By way of example, each soft key on the soft keyboard may have an alternate key input value associated with it, e.g., with the alternate key input value being displayed above the default value. To access the alternate key input value instead of the default key input value, a user may simply tap the soft key in question with two fingers instead of one. In another example, the combination of two normal soft key inputs received substantially simultaneously may result in an alternate key input value such that the user may tap both soft keys at the same time to get the alternate key input value. This for example avoids the user having to pause in his or her typing whenever a need for an alternate key input value occurs.

In another example, a soft keyboard may be used to mimic a physical keyboard. For example, an embodiment may detect a multi-touch input in which sequential inputs are utilized, with the first input extending in time to encompass the second input, with an alternate key input value being the result. By way of example, on a physical keyboard, a user may press and hold the shift control key and thereafter type upper case or capital letters and/or alternate key input values with keys while the holding down of the shift control key persists. When the user releases the shift key, the input reverts back to the default key input value. Likewise, an embodiment may provide an alternate key input value when a control key such as the shift key is touched, and remains touched, such that any sequential input occurring during this time registers as an alternate key input value, with the default key input value being restored responsive to the touch being withdrawn from the control key in question.

The illustrated example embodiments will be best understood by reference to the figures. The following description is intended only by way of example, and simply illustrates certain example embodiments.

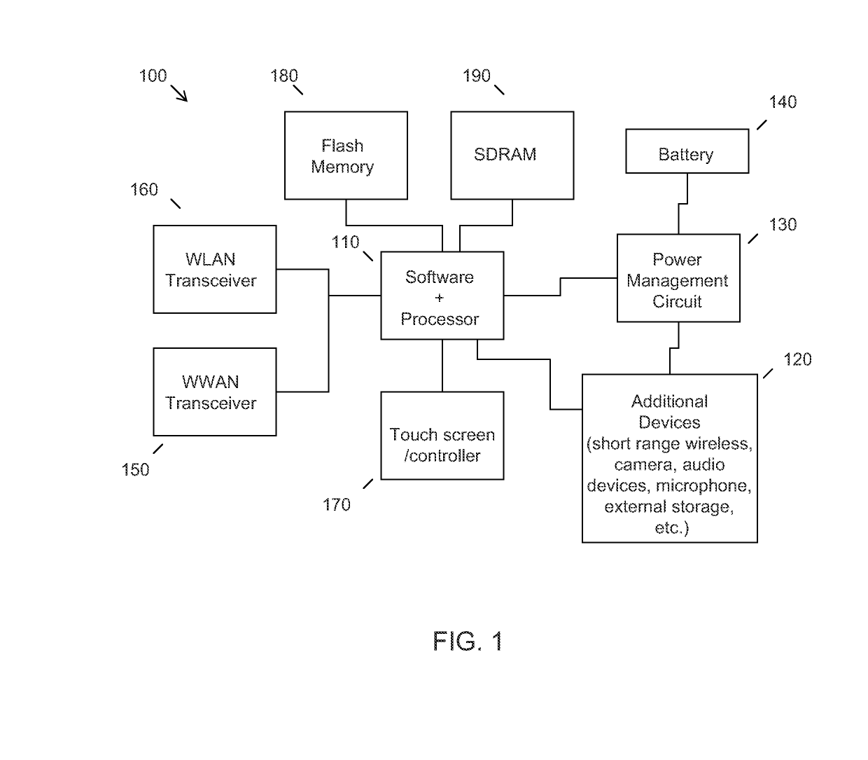

While various other circuits, circuitry or components may be utilized in information handling devices, with regard to smart phone and/or tablet-like circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included. System 100 may include a touch screen 170 for data input and display/rendering, e.g., including provisioning of a soft keyboard. System 100 also typically includes various memory devices, for example flash memory 180 and SDRAM 190.

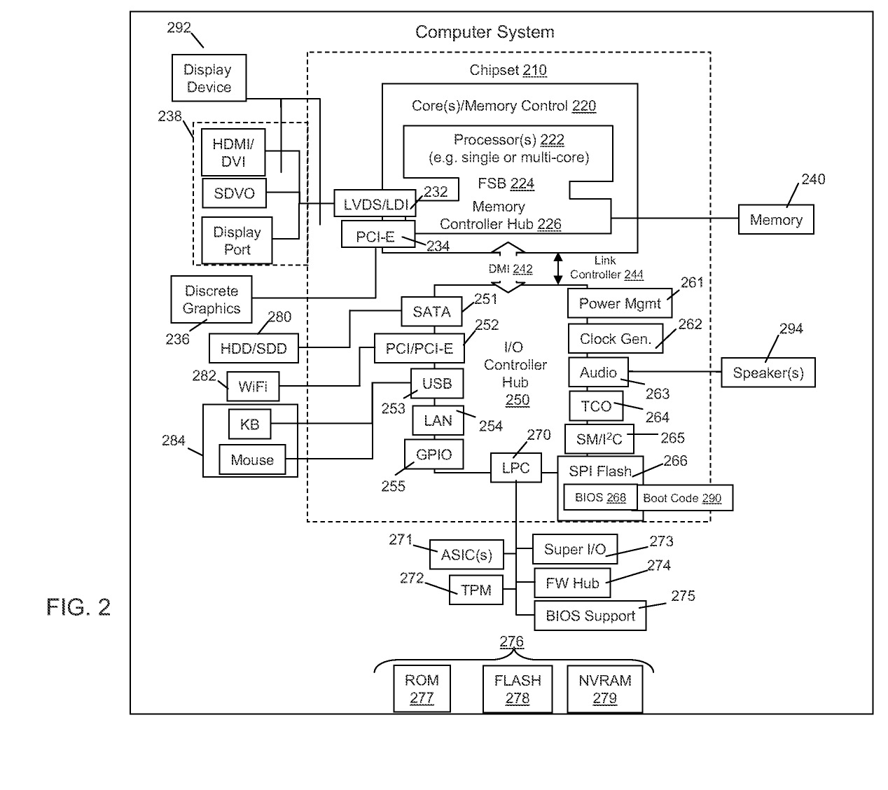

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be included in user devices that provide a soft keyboard. Such circuitry therefore may be utilized in implementing the various embodiments described herein, e.g., via altering the behavior of a conventional touch screen soft keyboard.

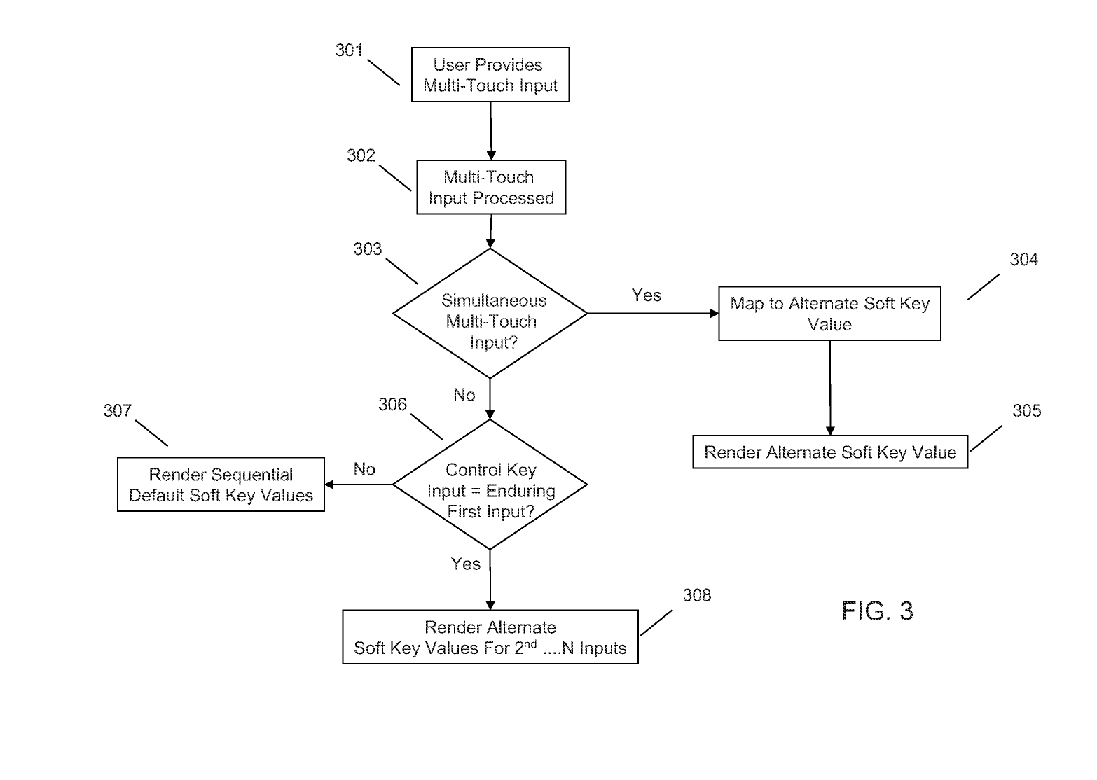

For example, and referring to FIG. 3, an embodiment detects, e.g., at a touch sensitive surface such as a touch screen of a tablet or smart phone, a multi-touch input to a soft keyboard at 301. The multi-touch input may take a variety of forms, e.g., substantially simultaneous or sequential. By way of example, the multi-touch input may include touch inputs that are provided simultaneously to two or more character keys and/or and a sequential multi-touch input. The sequential multi-touch input may include a first touch input provided to a control soft key, e.g., shift soft key, and a second touch input to a character soft key during a continuation of the first touch input, i.e., to the shift soft key in this example.

An embodiment may therefore process the received multi-touch inputs at 302 in order to determine the nature of the multi-touch event. For example, an embodiment may determine, e.g., at 303, if the multi-touch input detected includes a simultaneous multi-touch input to two or more soft key characters. If so, an embodiment may map the simultaneous multi-touch input to an alternate soft key input value at 304 and thereafter render an alternate soft key input value at 305. For example, an embodiment may proceed by inputting a value of “2” for a multi-touch input of “q” and “w” substantially simultaneously received on the soft keyboard. As described herein, the soft key alternate value may be displayed within a key or keys of a soft keyboard, e.g., a visual indication of “2” within either or both of “q” and “w” in this example.

An embodiment may determine that, while the multi-touch input is not simultaneous multi-touch input, e.g., as determined at 303, the multi-touch input detected is in a specific combination or pattern, e.g., detecting that a control soft key is the first input contact of a sequential multi-touch input, as illustrated at 306. Moreover, an embodiment may determine that the first control soft key input endures at 306, e.g., a press and hold event on the control soft key while other inputs are thereafter provided.

If so, an embodiment may input alternative soft key input values for sequential multi-touch inputs received thereafter, as illustrated at 308. This may be understood as mimicking the operation of a physical keyboard in which a user has depressed and held a control key, e.g., shift key, and then continued typing in other key values that register as shifted values. Otherwise, e.g., if the first input is not a control key input that endures, an embodiment may simply render sequential inputs with their default values and/or render the first input alone with an alternate value and thereafter enter default soft key input values for the remaining key inputs of the multitouch sequence, i.e., considering the first control key input does not endure to include in time the follow along soft key inputs.

As may be appreciated then, an embodiment permits a user to select alternate key input values using multi-touch inputs. This provides a more natural touch input interface and allows for a more seamless transition to alternate key input values.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
detecting, at a touch sensitive surface of an information handling device, a multi-touch input to a soft keyboard; and
rendering an alternative input mapped to the multi-touch input;
said multi-touch input being a substantially simultaneous multi-touch input to one or more character soft keys.

2. The method of claim 1, wherein said rendering an alternative input mapped to the multi-touch input comprises rendering a character not associated with a single touch input.

3. The method of claim 1, wherein said detecting comprises detecting that the multi-touch input is provided to a single soft key.

4. The method of claim 1, wherein said detecting comprises detecting that the multi-touch input is provided to two soft keys.

5. The method of claim 4, where said detecting comprises detecting that the multi-touch input is provided to two adjacent soft keys.

6. The method of claim 1, wherein said alternate input is displayed in a soft key involved in said multi-touch input.

7. An information handling device, comprising:
a touch sensitive surface;
a display;
a processor operatively coupled to the touch sensitive surface and the display;
a memory device that stores instructions accessible to the processor, the instructions being executable by the processor to:
detect, at the touch sensitive surface, a multi-touch input to a soft keyboard; and
render on the display an alternative input mapped to the multi-touch input;
said multi-touch input being a substantially simultaneous multi-touch input to one or more character soft keys.

8. The information handling device of claim 7, wherein to render an alternative input mapped to the multi-touch input comprises rendering a character not associated with a single touch input.

9. The information handling device of claim 7, wherein to detect comprises detecting that the multi-touch input is provided to a single soft key.

10. The information handling device of claim 7, wherein to detect comprises detecting that the multi-touch input is provided to two soft keys.

11. The information handling device of claim 10, where said detecting comprises detecting that the multi-touch input is provided to two adjacent soft keys.

12. The information handling device of claim 10, wherein said alternate input is displayed in a soft key involved in said multi-touch input.

13. The information handling device of claim 10, wherein the touch sensitive surface and the display are combined in a touch screen display device.

14. A product, comprising:
a storage device having code stored therewith, the code being executable by a processor and comprising:
code that detects, at a touch sensitive surface of an information handling device, a multi-touch input to a soft keyboard; and
code that renders an alternative input mapped to the multi-touch input;
said multi-touch input being a substantially simultaneous multi-touch input to one or more character soft keys.

15. A method, comprising:
detecting, at a touch sensitive surface of an information handling device, a multi-touch input to a soft keyboard; and
rendering an alternative input mapped to the multi-touch input;
said multi-touch input being a sequential multi-touch input comprising a first touch input provided to a control soft key and a second touch input to a character soft key during a continuation of said first touch input;
wherein said rendering an alternative input mapped to the multi-touch input comprises rending alternative inputs for a duration of time during which the first touch input is detected at the control soft key.

16. The method of claim 15, wherein said rendering an alternative input for a duration of time during which the first touch input is provided to the control soft key comprises rendering alternative inputs for character soft keys for the duration of time during which the touch input is detected at the control soft key.

17. The method of claim 16, wherein said rendering an alternative input comprises rendering repeated alternative inputs for sequential inputs detected for character soft keys.

18. The method of claim 16, wherein the control soft key comprises a shift key.

19. The method of claim 16, wherein the control soft key comprises an alternate key set display key.
